(19) United States
(12) Patent Application Publication
(10) Pub. No.: US 2007/0028517 A1
(43) Pub. Date: Feb. 8, 2007

(54) Bio-fumigation using Brassica seed

(76) Inventor: John M. Halliday, San Franciso, CA (US)

Correspondence Address: HOLLAND LAW OFFICE P.L.L.C., P.O. BOX 1840, BOISE, ID, 83701-1840, US

(21) Appl. No.: 11/197,055

(22) Filed: Aug. 3, 2005

(51) Int. Cl. A01C 1/00

(52) U.S. Cl. 47/58.1 SE

(57) ABSTRACT

The present invention is directed to a method for bio-fumigation using Brassica seeds. More particularly, the present invention is directed to a method for controlling monocot and dicot weed populations and maintaining plant growth and production through bio-fumigation using Brassica seeds. Brassica seeds may be mixed with zeolite to enhance the effect of bio-fumigation in some instances. The method for bio-fumigation of the present invention includes seeding using yellow mustard, (Brassica juncea (L.), Czernj. & Coss.), and/or rape, (Brassica napus L. var. napus).

### BACKGROUND OF THE INVENTION

1Technical Field

The present invention relates generally to control of weed populations, and more specifically to the control of weed populations employing bio-fumigation.

2. Background of the Invention

Methyl bromide is a widely used broad-spectrum soil fumigant and remains one of the top five most widely used agricultural chemicals in the world. Over eighty percent of methyl bromide is used in agriculture prior to planting to eliminate fungus, nematodes, microorganisms, and weeds in the soil. In the United States, methyl bromide is used mainly for strawberry, tomato and bell pepper crops. California is the largest user, followed by Florida. Use of methyl bromide, however, has been demonstrated to be a significant contributor to the “greenhouse” effect and depletion of ozone. Methyl bromide was listed in 1993, by the Parties of the Montreal Protocol, as an ozone-depleting compound. Consequently, methyl bromide was placed under the U.S. Clean Air Act of 1990. Accordingly, domestic production in 1994 will be frozen at 1991 levels and the importation and production of methyl bromide was slated to cease by the year 2001. Methyl bromide use continues today in the United States under “critical use” exemptions for a wide variety of crops and commodities. Under the current “critical use” program, use of methyl bromide has actually continued to increase in the United States since the year 2001.

Current practices for application of methyl bromide in agricultural production include injecting gaseous methyl bromide directly into the soil. In strawberry production, for instance, methyl bromide is injected into the soil of the beds in which strawberry plantings will or have been made and black plastic mulch is then placed over the beds, partially in an attempt to trap gases so that the effect of their use may be maximized.

A variety of substances have been proposed as substitute soil fumigants for the use of methyl bromide including metam sodium, chloropicrin, (tear gas), Dazomet, 1,3-D, (telone), Dichloroisopropyl ether, Enzone, each having its limitations and none apparently performing as well as methyl bromide. Additionally, non-fumigant methods have been investigated including systemic insecticides, formaldehyde, furfuraldehyde, inorganic enzyme inhibitors and systemic fungicides, all having limitations and none serving the broad-spectrum function provided by methyl bromide application. Investigators have also considered a variety of non-chemical soil disinfestations techniques including steam, solar and radiation treatment. Finally, consideration has been given to bio-fumigation as a potential.

The mechanisms of bio-fumigation by Brassica have been studied to some extent. It is known that about 20 different types of glucosinolates, (GSLs), are commonly found in Brassica. GSLs are known to liberate isothiocyanates, (ITCs), and other compounds on hydrolysis. The ITCs are the most toxic of the GSL hydrolysis products, having general biocidal properties as a result of interaction with proteins.

Advantage may be found in providing a method for controlling monocot and dicot weed populations through bio-fumigation using Brassica seeds that specifies optimal seeding density or an optimal range of seeding densities for seeding. More specifically, identifying optimal seeding densities or an optimal range of seeding densities for bio-fumigation using Brassica seeds may be advantageous. Therefore, one objective of the present invention is to provide a method for bio-fumigation using Brassica seeds wherein the method specifies optimal seeding densities or an optimal range of seeding densities for seeding.

### SUMMARY OF THE INVENTION

The present invention is directed to a method for cultivating a plant in a bed including the steps of seeding the bed with a first seed selected from a set of seeds including the Brassica seed variety, seeding the bed with a second seed variety for germination in the seeded bed and bio-fumagating the bed with an off gas produced as a result of the germination of the first seed selected from the set of seeds including the Brassica seed variety. The present invention is also directed to a method for controlling fungus, nematodes, microorganisms and monocot and dicot weed populations through bio-fumigation using Brassica seeds. Alternately, Brassica seeds may be mixed with a soil including zeolite to enhance the effect of bio-fumigation using Brassica seeds. Bio-fumigation using Brassica seeds on monocot and dicot weed populations. In particular, bio-fumigation using Brassica seeds on monocot and dicot weed populations, is disclosed using two varieties of Brassica seeds, yellow mustard (Brassica juncea (L)), and/or rape, (Brassica napus L. var. napus), at varying levels of seeding densities. Additionally, the present invention is directed to mixing zeolite with Brassica seed to enhance the effect bio-fumigation.

The present invention consists of the parts hereinafter more fully described and more particularly pointed out in the appended claims, it being understood that changes may be made in the form, size, proportions and minor details of construction without departing from the spirit or sacrificing any of the advantages of the invention.

### DETAILED DESCRIPTION

Bio-fumigation using Brassica seeds on monocot and dicot weed populations, is described in detail using Brassica seeds. In particular, bio-fumigation of monocot and dicot weed populations using Brassica seeds, is described in detail using two varieties of Brassica seeds, yellow mustard (Brassica juncea (L)), and rape, (Brassica napus L. var. napus). More particularly, bio-fumigation of monocot and dicot weed populations using Brassica seeds at specified levels of seeding densities is described. Additionally, the effect of mixing zeolite with Brassica seeds is described in detail. The following examples are offered in order to further illustrate the present invention.

### EXAMPLE 1

An experimental design included three levels of seeding densities for Brassica seed varieties including rape, mustard and rape plus mustard. Seeding protocol was as follows: Control, 0.00 L/m2, low density, 0.07 L/m2, medium density, 0.14 L/m2, high density, 0.29 L/m2. Additionally, seeding with a mixture of low density mustard plus a low density rape, net medium density 0.14 L/m2, was observed. In addition, the protocol included seeding with a low density, 0.07 L/m2, of rape or mustard seed plus a medium density, 0.14 L/m2, application of zeolite. The above combinations resulted in twelve distinct treatments. Four replications for each treatment were observed through out the experiment. Soil having a demonstrated a significant weed seed bank was used.

A first seeding of each of the twelve distinct treatments was manually cultivated into twelve beds to a depth of approximately 2.5 cm. The beds were covered with black plastic film. A total of 48 beds were prepared as described, twelve distinct treatments, times four replications, and placed on outside benches for a period of 15 days. Samples were taken of monocot and dicot weed populations separately at four spots per bed, a spot equaling a circle with 8 cm diameter, avoiding seeded Brassica seedlings. An average of sub-samples was used as a sample data of each flat and expressed as #/m². The described samples were compared to the control to determine if any of the treatments could suppress monocot and/or dicot weed populations as compared to the control plot. After 8 to 10 days from seeding, all flats exhibited a dense layer of seedlings under the black plastic mulch, the density of seedlings being related to the seeding density of the first seeding.

Testing showed that medium density mustard, high density mustard and high density rape had significantly lower weed populations than the control. At medium density, only mustard had significantly lower weed populations compared to the control. In the bed where both mustard and rape seeds were seeded at a net medium density, (0.14 L/m2), a weed population consistent with the average of the medium density mustard and medium density rape beds was observed. Zeolite was effective only when it was applied with high density mustard seed.

The protocol of illustrated by Example 1 establishes that the use of Brassica seeds as tested reduces both monocot and dicot weeds non-selectively. Without being bound by theory, it is thought that there may be two mechanisms of weed suppression: allelopathic effect of isothiocyanates released from the Brassica seeds, and/or physical barrier effect formed by densely seeded Brassica seedlings.

### EXAMPLE 2

A randomized block designed experiment of bio-fumigation methods including: a control, 0.00 L/m2, medium density rape, 0.21 L/m2, high density rape, 0.29 L/m2, medium density mustard, 0.21 L/m², high density mustard, 0.42 L/m², medium density rape plus zeolite, 0.21 L/m2 plus 0.21 L/m², and medium density mustard plus zeolite, 0.21 L/m2 plus 0.21 L/m². The above combinations resulted in nine distinct treatments. Brassica seeds and zeolite, where applicable, were applied on top of beds comprising a suitable soil were and mixed manually with the soil approximately 2.5 cm deep. The beds were immediately covered with black plastic mulch. Strawberries, (Fragaria chiloensis var. ananassa Duch) cv. Winter Chandler were planted in two rows per bed. Drip irrigation was applied and weeding was performed as needed. Plant response was sampled on select plants from week four, recording number of developed leaves, and developed flowers. Fruit harvest started on at week 24 and ended at week 40. At each harvest, fruit was harvested, counted and weighed from ten marked plants and separated into marketable and cull berries.

Developed leaf numbers increased considerably from week 16 through week 38. Flower development emerged at week 16 and peaked at weeks 28 through 32, fruit harvest started at week 23 and rapidly reduced in weeks 35 and 36. Throughout the growth period, no significant disease symptom was observed and a comparison of cumulative marketable fruit yield in g/plant, yields were shown to be comparable to control for medium density rape, 0.21 L/m2 without zeolite treatment and medium density mustard, 0.21 L/m²) without zeolite treatment.

While cumulative marketable fruit yield was comparable for all treatments, it was noted that marketable fruit yield during the early weeks of fruit harvest for these beds treated with medium density rape, 0.21 L/m2 and medium density mustard, 0.21 L/m². It is believed, without being bound by theory, that the main effect of biofumigation is pathogen suppression rather than plant growth enhancement. If pathogens are not limiting factors of the strawberry growth and production, biofumigation is unlikely to have significant effect even if it is effective in pathogen reduction. On the other hand, where beds are populated by various pathogens including fungus, nematodes, microorganisms and monocot and dicot weed populations, it is believed that biofumigation may have an effect, particularly on early plant growth and fruit production.

While this invention has been described with reference to the detailed embodiments, it is not intended that the description be construed in a limiting sense. Various modifications to the described embodiments, as well as additional embodiments of the invention, will be apparent to persons skilled in the art upon reference to this description. It is therefore contemplated that the appended claims will cover any such modifications or embodiments as fall within the true scope of the invention.

What is claimed is:

1. A method for cultivating a plant in a bed, the method including the steps of:
seeding the bed with a first seeding selected from a set of seeds including the Brassica seed variety;
seeding the bed with a second seeding variety for germination in the seeded bed; and
bio-fumagating the bed with an off gas produced as a result of the germination of the first seeding.

2. The method for cultivating a plant in a bed of claim 1 wherein the step of seeding the bed with a Brassica seed further comprises seeding the bed with Brassica napus seed, said seeding having a seeding density greater than or equal to 0.14 L/m².

3. The method for cultivating a plant in a bed of claim 1 wherein the step of seeding the bed with a Brassica seed further comprises seeding the bed with Brassica juncea seed, said seeding having a seeding density greater than or equal to 0.14 L/m².

4. The method for cultivating a plant in a bed of claim 1 wherein the step of seeding the bed with a Brassica seed further comprises seeding the bed with Brassica napus seed, said seeding having a seeding density greater than or equal to 0.21 L/m2.

5. The method for cultivating a plant in a bed of claim 1 wherein the step of seeding the bed with a Brassica seed further comprises seeding the bed with Brassica juncea seed, said seeding having a seeding density greater than or equal 0.21 L/m2.

6. The method for cultivating a plant in a bed of claim 1 wherein the step of seeding the bed with a Brassica seed further comprises seeding the bed with Brassica napus seed, said seeding having a seeding density greater than or equal to 0.29 L/m2.

7. The method for cultivating a plant in a bed of claim 1 wherein the step of seeding the bed with a Brassica seed further comprises seeding the bed with Brassica juncea seed, said seeding having a seeding density greater than or equal 0.29 L/m2.

8. The method for cultivating a plant in a bed of claim 1 wherein the step of seeding the bed with a Brassica seed further comprises:
seeding the bed with Brassica juncea seed, said seeding having a seeding density greater than or equal 0.29 L/m2; and
mixing zeolite in the bed with the Brassica juncea seed.

9. The method for cultivating a plant in a bed of claim 1 wherein the step of planting a plant in the seeded bed further comprises planting a plant that produces a harvestable fruit in the seeded bed.

10. The method for cultivating a plant in a bed of claim 1 wherein the step of planting a plant in the seeded bed further comprises planting a strawberry plant in the seeded bed.

11. The method for cultivating a plant in a bed of claim 1 wherein the step of planting a plant in the seeded bed further comprises planting a tomato plant in the seeded bed.

12. The method for cultivating a plant in a bed of claim 1 wherein the step of planting a plant in the seeded bed further comprises planting a pepper plant in the seeded bed.

13. A method for cultivating a plant in a bed including the steps of:
seeding the bed with a Brassica seed variety, having a seeding density greater than or equal than 0.21 L/m2; and
planting a plant that bears a harvestable fruit in the seeded bed.

14. The method for cultivating a plant in a bed of claim 13 wherein the step of seeding the bed with a Brassica seed further comprises seeding the bed with Brassica napus seed, said seeding having a seeding density greater than or equal to 0.21 L/m2.

15. The method for cultivating a plant in a bed of claim 13 wherein the step of seeding the bed with a Brassica seed further comprises seeding the bed with Brassica juncea seed, said seeding having a seeding density greater than or equal 0.21 L/m2.

16. The method for cultivating a plant in a bed of claim 13 wherein the step of planting a plant in the seeded bed further comprises planting a strawberry plant in the seeded bed.

17. The method for cultivating a plant in a bed of claim 13 wherein the step of planting a plant in the seeded bed further comprises planting a tomato plant in the seeded bed.

18. The method for cultivating a plant in a bed of claim 13 wherein the step of planting a plant in the seeded bed further comprises planting a pepper plant in the seeded bed.
